(19) United States
(12) Patent Application Publication
(10) Pub. No.: US 2023/0242754 A1
(43) Pub. Date: Aug. 3, 2023

(54) POLYMER COMPOSITE COMPRISING OILSEED MEAL

(71) Applicant: CODA Intellectual Property B.V., s'Gravenhage (NL)

(72) Inventor: Daniel Eric Lynch, Rotterdam (NL)

(73) Assignee: CODA Intellectual Property B.V., s'Gravenhage (NL)

(21) Appl. No.: 18/193,348

(22) Filed: Mar. 30, 2023

Related U.S. Application Data
(63) Continuation of application No. PCT/NL2021/050591, filed on Sep. 29, 2021.

(30) Foreign Application Priority Data
Sep. 30, 2020 (NL) 2026593

(51) Int. Cl. C08L 67/04; C08K 5/053; C08K 3/34; C08K 3/22; C08J 3/20; C08J 5/18

(52) U.S. Cl. CPC C08L 67/04; C08K 5/053; C08K 3/34; C08K 3/22; C08J 3/203; C08J 5/18; C08L 2205/06; C08L 2201/06; C08K 2003/2227; C08L 2203/16; C08J 2367/04; C08J 2405/00

(57) ABSTRACT

The invention concerns a polymer composite comprising:
a. polymer in an amount of 5-94.5% by weight of the overall weight;
b. milled oilseed meal in an amount of at least 5% by weight of the overall weight;
c. plasticizer in an amount from 5-50% w/w of component b);
d. optional filler, and
e. optional additive,
wherein
c) is a solid plasticizer with a melting temperature in the range of 70 to 210°. The invention also concerns a process for its preparation, an intermediate, and a solid article comprising the polymer composite.

### CROSS REFERENCE TO RELATED APPLICATIONS

This application is a continuation of International Application No. PCT/NL2021/050591, filed on 29 Sep. 2021, which claims priority to Netherlands Application No. 2026593 NL, filed 30 Sep. 2020, the contents of each of which are hereby incorporated by reference in their entirety herein.

### TECHNICAL FIELD

This invention concerns a polymer composite comprising oilseed meal. More in particular, this invention concerns a polymer composite comprising an increased amount of oilseed meal.

### BACKGROUND

Oilseeds are seeds primarily grown for the extraction of edible oils, although they may also include seeds grown for the purpose of oil extraction for any application, such as in fragrances and personal care. Whole oilseeds contain high concentrations of energy and moderate concentrations of protein and fibre. Major oilseeds include soybean, rapeseed (canola), sunflower, and palm oil.

The processes utilized in the extraction of the oil from the oilseed (defatting of the oilseed) essentially fall into three categories: solvent-extracted, hot-pressed (or expeller-extracted), and cold-pressed. Solvent extraction is commonly undertaken (industrially) using hexane, following mechanical crushing of the oilseeds, and results in removal of 97-99% of the oil content, with oil content <1.5% normally expected. Pressed extraction is done mechanically through physical squeezing of the oil from the oilseed with cold-pressing occurring below 60° C./140° F. Hot-pressing/expeller extraction involves heated pre-treatment of the oilseeds before pressing. Expected oil extraction content by pressing is normally <95%.

The remains of the oilseed following oil extraction are commonly referred to as meal, expeller, or cake (press-cake). More accurately, solvent extracted oilseed results in meal, hot-pressed extraction results in expeller meal, and cold-pressed extraction results in expeller cake. For the purposes of this patent, meal is defined as the resultant material of solvent extraction processes, containing less than 3% preferably equal to or less than 1.5 w/w of oil. For instance, solvent-extracted rapeseed meal must not contain more than 2-3% oil, https://www.feedipedia.org/node/52.

Oilseed meals are a major source of protein in livestock feeds with protein levels usually in excess of 20%. Examples of commercial meals include, but are not limited to, soybean meal or soymeal, palm meal or palm kernel meal, coconut meal or copra meal, sunflower meal, peanut meal or groundnut meal, cottonseed meal, rapeseed meal or rapemeal or canola meal, castor bean meal, linseed meal, flaxseed meal or flaxmeal, safflower meal, camelina meal, corozo palm nut meal or corozo meal, grape seed meal, jatropha kernel meal, mustard seed meal, maize germ meal, sal seed meal or Shorea Robusta seed meal, sesame seed meal, hemp seed meal, tobacco seed meal, watermelon seed meal, niger seed meal, rice bran meal, wheat germ meal, borage meal, blackcurrant meal, evening primrose meal, rosehip meal, Buglossoides arvensis (Ahiflower) meal, jojoba meal, and almond meal, for example.

Some oilseed meals have been proven to have antioxidant and free-radical scavenging properties similar to their extracted oils.

It is commonly known that the oils extracted from oilseeds have been used as functional additives (mainly plasticizers) in polymers, including biodegradable polymers such as polylactic acid and poly(butylene succinate). This has particularly been the case for linseed oil and other epoxidized oils.

It is also widely known that specific protein isolates, separated by chemical means from their respective meals and with the aid of varying plasticizers, have been reported for use in polymer films, both as the principal component and as composites with other common polymers. This is strongly the case for the protein isolates of soy, rapeseed (canola) and cottonseed.

However, reported cases of polymer composites containing milled oilseed meal (with oil content <3%) are less widely reported.

Defatted linseed cake (acetone modified) was incorporated into polylactic acid at loading levels between 5-30% w/w by O. Mysiukiewicz and M. Barczewski in “Utilization of linseed cake as a postagricultural functional filler for poly(lactic acid) green composites” Journal of Applied Polymer Science 2018, DOI: 10.1002/APP.47152, although the residual oil content of the defatted linseed cake was measured at 17.4% and should not be considered as a meal.

The same acetone-defatted linseed cake was further incorporated into polylactic acid up to 40% w/w loading by M. Barczewski, O. Mysiukiewicz, J. Szulc and A. Klozinski in “Poly(lactic acid) green composites filled with linseed cake as an agricultural waste filler. Influence of oil content within the filler on the rheological behaviour” Journal of Applied Polymer Science 2019, DOI: 10.1002/APP.47651.

Two quotes from this paper read (text in brackets is added for explanation):

“It can be seen that in case of materials with 20 wt % and more of both (linseed cake, LC, and acetone modified linseed cake, LCA) filler types, the flow throughput during measurement became extremely high, which is reasonable if compared to wall slip effects observed also in case of capillary and torque rheological measurements. High MFI (melt flow index) values observed for composites containing 20-40 wt % of the fillers with allowance for results of torque rheometry, suggest that the incorporation of higher than 10 wt % of the filler may provide strong limitations in melt processing and production stability.”

“Unfortunately, in case of composites containing more than 20 wt % of the LC and LCA (linseed cake and acetone modified linseed cake), the high amount of oil in both types of the LC fillers (pure and defatted) causes strong limitations during plastification in a dynamic kneader chamber.”

A petroleum ether defatted linseed expeller resulting in an oil content of 4.6% and a second defatting process resulting in an oil content of 0.9% were both reported by Olga Mysiukiewicz, Mateusz Barczewski, Katarzyna Skórczewska, Joanna Szulc and Arkadiusz Klozinski in “Accelerated Weathering of Polylactide-Based Composites Filled with Linseed Cake: The Influence of Time and Oil Content within the Filler”, Polymers 2019, 11, 1495. The second of these materials can be considered as a meal. Both were incorporated into polylactic acid at a loading level of 10% w/w without the use of any other additives. The 0.9% sample was found to be stronger but more brittle as opposed to identical samples incorporating higher levels of linseed oil content.

The same materials were also reported by O. Mysiukiewicz, K. Salasinska, M. Barczewski and J. Szulc in “The influence of oil content within lignocellulosic filler on thermal degradation kinetics and flammability of polylactide composites modified with linseed cake”, Polymer Composites 2020, https://doi.org/10.1002/pc.25727.

Rapeseed meal (with no specified oil content) pre-compounded 60:40 with glycerol as a plasticizer was injection moulded into 1 mm thick plaques along with 5-20% w/w polycaprolactone (PCL) polymer at temperatures no greater than 120° C. by M. Delgado, M. Felix and C. Bengoechea in “Development of bioplastic materials: From rapeseed oil industry by products to added-value biodegradable biocomposite materials” Industrial Crops & Products 2018, 125, 401-407.

Corn gluten meal, canola meal, cottonseed meal, sunflower meal and linseed meal (with no specified oil contents) plasticized using aqueous urea solutions are covered in U.S. Pat. No. 10,513,063 for their use as thermosetting polymers in the production of injection-moulded articles.

The purpose of the present invention is to find a solution that allows inclusion of greater amounts of milled oilseed meal, e.g. milled borage meal, milled rosehip meal and/or milled Ahiflower without loss of strength or flexibility. Moreover, the purpose of the present invention is to find polymer composites that can be moulded, e.g., into disposable articles such as coffee capsules, cutlery, straws, drink stirrers, food trays, single-serve packaging, such as a cup, cap, container and/or lid, or any other single-use items, etc., i.e. with sufficient strength to form a disposable article with a wall thickness larger than 250 micrometres.

### SUMMARY OF THE INVENTION

A polymer composite is provided as claimed in claim 1, comprising.
a. polymer in an amount of 5-94.5% by weight of the overall weight;
b. milled oilseed meal in an amount of at least 5% by weight of the overall weight;
c. plasticizer in an amount from 5-50% w/w of component b);
d. optional filler, and
e. optional additive,
   wherein
      c) is a solid plasticizer with a melting temperature in the range of 70 to 210° C.

Also provided is a process for preparing the polymer composite, an intermediate for preparing the polymer composite and articles comprising the polymer composite.

### DETAILED DESCRIPTION OF THE INVENTION

It has been found that with the addition of at least 5%, preferably at least 15% by weight of a solid plasticizer based on the milled oilseed meal, optionally together with an appropriate filler, the milled oilseed meal can form a plastic composite material with a polymer even at high loading levels, e.g., higher than 20% w/w or even higher than 40% w/w based on the milled oilseed meal and polymer, with sufficient strength to form a disposable article with a wall thickness larger than 250 micrometres (10 mils).

For use in the present invention, any type of oilseed meal as defined above can be used as component b). This current invention specifically focusses on milled oilseed meals based on any one or more of sunflower, borage, cottonseed, Ahiflower, safflower, rosehip, canola, blackcurrant, palm kernel, rapeseed, linseed, and evening primrose. Prior to compounding, the oilseed meal is sieved/milled to a fine powder, having a particle size smaller than 1 mm, preferably smaller than 500 micrometres. This is preferably done in multiple stages to obtain a uniform small particle size. For instance, milled borage meal powder may be used. Similar considerations apply with respect to rosehip, Ahiflower, rapeseed, linseed, evening primrose, and blackcurrant or combinations thereof.

Milling is preferably carried out on dry material e.g. in order to more easily obtain a uniform small particle size and/or to reduce the amount of introduced liquid such as water. In an embodiment, materials may thus be dried prior to milling. Hence, although in this specification, materials may only be referred to as being milled, the present invention alternatively or additionally refers to embodiments that the materials are dried milled and thus, if necessary, the wording “milled” may be replaced throughout the specification by the wording “dried milled” where appropriate. In other words, “milled” has to be interpreted as meaning “milled and/or dried milled” unless specifically stated otherwise.

The milled oilseed meal may be used at low loading levels, starting at 5% by weight of the overall weight, but preferably is used at loading levels in excess of 20%, e.g., at loading levels of 20-90%, more preferably at loading levels of 20-80%, still more preferably at loading levels of 20-70% by weight of the overall weight, or at loading levels in excess of 40%, e.g., at loading levels of 40-90%, more preferably at loading levels of 40-80%, still more preferably at loading levels of 40-70% by weight of the overall weight. The milled oilseed meal may be mixed, e.g., up to 100%, preferably up to 50% by weight of component b), with milled expeller/cake, milled pomace, milled distillers' grain, milled brewer's grain (or brewer's spent grain/draff), milled biscuit meal (or biscuit cereal meal), milled whole seeds, milled whole roots, milled whole beans, milled stems and/or leaves, whole grain flour of cereal grass, coffee grounds, and flour of pulse, or combinations thereof. For instance, a mixture of two materials such as milled borage meal and either milled biscuit meal, or areca catechu leaf sheath powder may be used. When mixing the milled oilseed meal with other oilseed expellers, cakes, and the like, the amount of solid plasticizer is calculated on the combined (total) weight of the oilseed meal mixture.

Considering that some of the oils of oilseeds are known as plasticizers for polymers then the mixture of a meal with an expeller (having a higher oil content) can provide control over the handling and introduction of the oil to the composite mixture.

Suitable expellers may include but are not limited to the expeller of sunflower seeds, rapeseed, linseed, peanut, palm fruit, sesame seed, castor seed, and sugar beet pulp. Suitable meals may include but are not limited to the meal of sunflower, borage, cottonseed, Buglossoides arvensus (Ahiflower), safflower, rosehip, canola, blackcurrant, palm kernel, rapemeal, and evening primrose. Biscuit meal, or biscuit cereal meal, may include either a mixture of or the individual components of the crumbed waste of cooked and processed biscuit, cake and cereal food products. Cereal grasses include staple crops such as maize, wheat, rice, barley, oat and millet and hybrids such as triticale, as well as feed for animals, such as canary seeds. Pulses include annual leguminous crops yielding from one to twelve grains or seeds of variable size, shape and colour within a pod, that are used for both food and feed and that are harvested solely for dry seed, such as field peas, faba beans and lupin beans. Suitable examples of pomace may include grape pomace, olive pomace, apple pomace, or the solid remains of other fruits or vegetables after pressing for juice or oil.

The polymer composite may be made from any polymer as component a), but preferably a thermoplastic polymer is used. Suitable polymers include synthetic and natural polymers, e.g., biobased and biodegradable polymers. Suitable thermoplastic materials include polyamides (such as nylon), acrylic polymers, polystyrenes, polypropylene (PP), polyethylene (including low-density polyethylene (LDPE) and high density polyethylene (HDPE), acrylonitrile butadiene styrene (ABS), polyglycolic acid, polycarbonates, polybenzimidazole, poly ether sulphone, polyether ether ketones (PEEK), polyetherimide, polyphenylene oxide, polyphenylene sulphide, polyvinyl chloride, and polytetrafluoroethylene, or any suitable mixture thereof.

Elastomers, or combinations of thermoplastic polymers with elastomers may also be used. Suitable elastomers include natural and synthetic rubbers, chloroprene, neoprene, isoprene, polybutadiene, butyl rubber, halogenated butyl rubber, styrene-butadiene, nitrile rubber, latex, fluoroelastomers, silicone rubbers, epichlorhydrin, poly ether block amides, ethylene vinyl acetate (EVA) and ethylene vinyl alcohol (EVOH) for example. The elastomer may comprise a thermoplastic elastomer, which may be selected from styrenic block copolymers (TPE-s), thermoplastic olefins (TPE-o), elastomeric alloys (TPE-v or TPV), thermoplastic polyurethanes (TPU), thermoplastic copolyester (TPE-E) and thermoplastic polyamides, for example.

Thermoset polymers, or combinations of thermoplastic polymers with thermoset polymers may also be used. Suitable thermoset polymers include epoxy resins, melamine formaldehyde, polyester resins and urea formaldehyde, for example.

Suitable acrylic polymers (which may be thermoplastics, thermosets or thermoplastic elastomers) include polyacrylic acid resins, polymethyl methacrylates, polymethyl acrylates, polyethyl acrylates, polyethyl ethacrylates, and polybutyl methacrylates, for example.

Suitable polyesters include polyglycolide (PGA), polylactide or poly(lactic acid) (PLA), poly(lactide-co-glycolide) (PLGA), polycaprolactone (PCL), poly(butylene succinate) (PBS) and its copolymers, e.g. poly(butylene succinate-co-adipate) (PBSA), poly(butylene adipate-co-terephtalate) (PBAT), a linear copolymer of N-acetyl-glucosamine and N-glucosamine with β-1,4 linkage, cellulose acetate (CA), poly(hydroxybutyrate) (PHB) or other polyhydroxyalkanoates (PHA), poly(hydroxybutyrate-co-hydroxyvalerate) (PHBV), or any suitable mixture thereof. Most preferably either PLA or PBS is used as component a). Most preferably, for improved biodegradability, the polymer composite comprises either PLA or PBS in an amount between 30-50% w/w of the overall mixture.

Plasticizers are an important class of low molecular weight non-volatile compounds that are widely used in polymer industries as additives. Plasticizers for thermoplastics are, in general, high boiling point liquids, with average molecular weights of between 300 and 600, and linear or cyclic carbon chains (14-40 carbons). However, the purpose of the plasticizer for a biomaterial is to prevent agglomeration of the carbohydrate/protein chains so that the biomaterial mixes with the polymer and the two become a single plastic mass. For the purpose of the present invention, the plasticizer must be compatible with component b), and be different from component b).

Glycerol, polyethylene glycol, and sorbitol are the most commonly used plasticizers in the protein-based (from protein isolate) bioplastic studies whereas the present invention requires the exclusive use of a solid plasticizer with a melting temperature in the range of 55 to 210° C., preferably in the range of 70 to 210° C., more preferably in the range 80 to 210° C., and most preferably in the range 90 to 210° C. The plasticizer may be selected from polyols, polyfunctional alcohols, amphipolar plasticizers such as carboxylic acids and esters, for instance mono, di-, and tri-glyceride esters; mono-, di- and oligosaccharides and combinations thereof. Polyols have been found to be particularly effective. Suitable plasticizers include sorbitol, maltitol, sucralose, threitol, erythritol, psicose, allose, talose, ribitol, tagatose, arabinose, galactitol, lactitol, arabitol, glyceraldehyde, iditol, sorbose, ribose, galactose, volemitol, mannitol, fucitol, xylose, xylitol, trehalose, cellobiose, raffinose, glucose, mannose, fructose, isomalt, polydextrose and sucrose; and/or combinations thereof. For instance, xylose, with a melting point of 144-145° C. and/or sorbitol, with a melting point of 94-96° C., and/or xylitol, with a melting point of 92-96° C. may be used. An advantage of using sorbitol over xylose is the higher tensile strength of the resulting polymer composite. An advantage of using xylitol over sorbitol and xylose is the higher tensile strength of the resulting polymer composite. Further, xylitol has a lower solubility in water then sorbitol meaning that when the polymer composite is used in solid articles that during use are subjected to water, e.g., hot water, as in a coffee machine, the chance of xylitol being dissolved into the water is lower.

Also, a mixture of a solid plasticizer and a liquid plasticizer may be used, provided the mixture has a melting temperature in the range of 55 to 210° C., preferably in the range of 70 to 210° C., more preferably in the range 80 to 210° C., and most preferably in the range 90 to 210° C. The amount of liquid plasticizer is preferably small, e.g., up to 10% by weight of component c).

The plasticizer may be used in an amount from 15-50% w/w of component b), preferably between 22-40% w/w of component b).

Additional, optional components of the polymer composite include fillers, such as mineral fillers and/or natural fibres and/or carbon-based fillers.

Suitable mineral fillers include carbonates (including bicarbonates), phosphates, ferrocyanides, silica, silicates, aluminosilicates (including all forms of clay minerals, mica and talc), titanium dioxide, or combinations thereof. For instance, a nepheline syenite may be used or any similar filler derived from silica-undersaturated and peralkaline igneous rocks, as well as any type of bentonite.

Natural fibres include cellulose or lignocellulosic fibres such as plant or vegetable fibres from the blast, leaf, seed, wood, or stem. For instance, wood cellulose fibre may be used. Carbon based fillers include carbon nanotubes (CNT), graphene, fullerene, graphite, and amorphous carbon.

The filler may be used in an amount from 0-96% w/w of the overall mixture, preferably between 1-40% w/w of the overall mixture.

Optional additional components include compatibilizers, fragrances, heat and UV stabilizers, colouring agents and the like. Suitable compatibilizers include any acrylic grafted thermoplastics (for example: maleic anhydride grafted polyethylene, polypropylene, or polylactic acid), interface-active high-molecular-weight peroxides, poly(2-ethyl-2-oxazoline), any esters of citric acid, aromatic; carbodiimides (for example: BioAdirnide from Lanxess), wax-based emulsion additives (for example: Aquacer from BYK Additives), organo-silane coupling agents, and isocyanate (or diisocyanate) coupling agents (for example: methylenediisocyanate).

The additional components may be used in an amount from 0-30% by weight of the overall mixture, preferably between 0-15% by weight of the overall mixture.

The polymer composite is made by so-called “hot compounding” techniques, where the components are combined under heat and shearing forces that bring about a state of molten plastic (fluxing) which is shaped into the desired product, cooled and allowed to develop ultimate properties of strength and integrity. Hot compounding includes 10alendaring, extrusion, injection and compression moulding. This is carried out at temperatures, pressures and processing conditions specific to the selected polymer. For instance, when using PLA the temperature is preferably in the range of 130 to 215° C., more preferably in the range of 130 to 210° C., even more preferably in the range of 130 to 185° C., and most preferably between 130 to 165° C.

The polymer composite may also be made by a multistep process, wherein the milled oilseed meal is first compounded with the solid plasticizer and pelletized and the pellets or grinded pellets are then combined with the polymer. Additional components may be added in any of the steps of the multistep process. The present invention therefore also provides pellets or grinded pellets of milled oilseed meal compounded and pelletized with plasticizer and other components if any, as intermediate product for combination with the polymer to produce the polymer composite.

The result of the process can be in the form of a solid article (or layer or portion thereof) and may comprise a compounded pellet, extruded work-piece, injection-moulded article, blow moulded article, rota-moulded plastics article, two-part liquid moulded article, laminate, 3D printer filament, felt, woven fabric, knitted fabric, embroidered fabric, nonwoven fabric, geotextiles, fibres or a solid sheet, for example.

The solid article may be in the form of a coffee capsule, cutlery, straw, drink stirrer, food tray, or single-serve packaging, such as a cup, cap, container and/or lid, or any other single-use item.

The solid article is preferably suited to be used and/or cleaned in water environments with a temperature above room temperature, preferably a temperature above 30° C., more preferably a temperature above 50° C., even more preferably a temperature above 60° C., and most preferably a temperature above 80° C. The solid article may for instance be used in a coffee machine using water at a temperature between 80 to 100° C., e.g., between 87 and 92° C.

The solid article is preferably suited to be used under pressure, e.g., a pressure above 2 bar, preferably a pressure above 4 bar, more preferably a pressure above 6 bar, and most preferably a pressure above 8 bar, e.g., as used in a coffee machine.

The solid article preferably has a minimum thickness above 250 micrometres, preferably above 350 micrometres, more preferably above 500 micrometres, and most preferably above 600 micrometres.

The invention is illustrated by the below examples.

### Example 1

275 grams of PLA (Ingeo® 3251D from Natureworks LLC), 225 grams of borage meal (New Holland Extraction Ltd; oil content 0.9% w/w) milled in a laboratory grain mill grinder (sieved through a 1 mm sieve) and 67.5 grams of xylitol (sieved through a 1 mm sieve) was mixed in a sealed plastic bag into a homogenous mixture (Mixture 1).

### Example 2

275 grams of Ingeo 3251D PLA, 225 grams of rosehip meal (New Holland Extraction Ltd; oil content <0.5% w/w) milled in a laboratory grain mill grinder (sieved through a 1 mm sieve) and 67.5 grams of xylitol (sieved through a 1 mm sieve) was mixed in a sealed plastic bag into a homogenous mixture (Mixture 2).

### Example 3

275 grams of Ingeo 3251D PLA, 225 grams of Ahiflower meal (New Holland Extraction Ltd; oil content 0.7% w/w) milled in a laboratory grain mill grinder (sieved through a 1 mm sieve) and 67.5 grams of xylitol (sieved through a 1 mm sieve) was mixed in a sealed plastic bag into a homogenous mixture (Mixture 3).

### Example 4

275 grams of Ingeo 3251D PLA, 225 grams of evening primrose meal (New Holland Extraction Ltd; oil content 0.9% w/w) milled in a laboratory grain mill grinder (sieved through a 1 mm sieve) and 67.5 grams of xylitol (sieved through a 1 mm sieve) was mixed in a sealed plastic bag into a homogenous mixture (Mixture 4).

### Example 5

275 grams of Ingeo 3251D PLA, 225 grams of blackcurrant meal (New Holland Extraction Ltd; oil content <3% w/w) milled in a laboratory grain mill grinder (sieved through a 1 mm sieve) and 67.5 grams of xylitol (sieved through a 1 mm sieve) was mixed in a sealed plastic bag into a homogenous mixture (Mixture 5).

### Example 6

275 grams of Ingeo 3251 D PLA, 225 grams of rapemeal (Cargill plc; oil content 2-4% w/w) milled in a laboratory grain mill grinder (sieved through a 1 mm sieve) and 67.5 grams of xylitol (sieved through a 1 mm sieve) was mixed in a sealed plastic bag into a homogenous mixture (Mixture 6).

### Example 7

150 grams of Ingeo 3251D PLA, 192 grams of evening primrose meal milled in a laboratory grain mill grinder (sieved through a 1 mm sieve), 58 grams of xylitol (sieved through a 1 mm sieve) and 100 grams of HiFill™ N800 (nepheline syenite powder as inorganic filler from Sibelco UK Ltd) was mixed in a sealed plastic bag into a homogenous mixture (Mixture 7).

### Example 8

275 grams of Ingeo 3251D PLA, 225 grams of hot-pressed rapeseed expeller (Yelo Enterprises Ltd; oil content 8-10% w/w) milled in a laboratory grain mill grinder (sieved through a 1 mm sieve) and 67.5 grams of xylitol (sieved through a 1 mm sieve) was mixed in a sealed plastic bag into a homogenous mixture (Mixture 8).

### Example 9

275 grams of Ingeo 3251D PLA, 225 grams of cold-pressed linseed expeller (Pureflax Linseed Original from Compton Grove Farm UK) milled in a laboratory grain mill grinder (sieved through a 1 mm sieve) and 67.5 grams of xylitol (sieved through a 1 mm sieve) was mixed in a sealed plastic bag into a homogenous mixture (Mixture 9).

### Example 10

275 grams of Ingeo 3251D PLA, 225 grams of sugar beet pulp (British Sugar plc) milled in a laboratory grain mill grinder (sieved through a 1 mm sieve) and 67.5 grams of xylitol (sieved through a 1 mm sieve) was mixed in a sealed plastic bag into a homogenous mixture (Mixture 10).

### Example 11

150 grams of Ingeo 3251D PLA, 192 grams of hot-pressed rapeseed expeller milled in a laboratory grain mill grinder (sieved through a 1 mm sieve), 58 grams of xylitol (sieved through a 1 mm sieve) and 100 grams of Premium Quest™ Bentonite (calcium bentonite powder as inorganic filler from Amcol Minerals Europe Ltd) was mixed in a sealed plastic bag into a homogenous mixture (Mixture 11).

### Examples 12-18

Mixtures 1-7 (from Examples 1-7) were individually poured into the hopper of a Negri Bossi v55 injection moulding machine with a 32 mm diameter screw and a L/D ratio of 20:1 operating at temperatures ranging from 130 to 185° C. Each molten plasticized mixture was injection moulded in a single-cavity tool fitted with a single-drop hotrunner system into capsules suitable for use in a Nespresso®-style coffee machine.

### Examples 19-22

Mixtures 8-11 (from Examples 8-11) were individually poured into the hopper of a Negri Bossi v55 injection moulding machine with a 32 mm diameter screw and a L/D ratio of 20:1 operating at temperatures ranging from 165 to 185° C. Each molten plasticized mixture was injection moulded in a twin-cavity tool fitted with a single-drop hotrunner system into drink stirrer sticks suitable for stirring beverages.

### Example 23

20 kgs of evening primrose meal was run through a Magico EMC70 electric mill from AMA S.p.A. fitted with a 1 mm sieve to break up any agglomerated clumps. The resultant powder was then mixed with 30% by weight of xylitol (sieved through a 2 mm sieve) in a tumble mixer to create a mixed powder of about 26 kgs weight. This mixture was then compounded with Ingeo 3251 D PLA in a ratio of 64:36 evening primrose meal/xylitol:PLA on a Werner and Pfleiderer ZSK 25 twin-screw compounder fitted with a ZS-B 25 twin-screw side feeder. The screw profile used is given in Table 1 along with the respective injection points for the component materials. The temperature settings along the barrel were 170, 190, 170, 170, 170, 170, 170, 170° C. The compounded filament was cooled in a water bath, dried under an air knife and pelletized using a SG-E 60 from Intelligent Pelletizing Solutions GmbH & Co KG. Pellets were dried overnight in a Dryplus 250 from Vismec s.r.l at 80° C.

TABLE 1
Screw profile with material inclusion points

| | | |
|---|---|---|
| Conveying | 16/16 | (PLA) |
| | 36/36 (× 2) | |
| | 36/18 | |
| | 36/36 | |
| | 36/18 | |
| Kneading | 45/5/36 | |
| | 45/5/18 | |
| | 45/5/18 (× 2) | |
| Conveying | 36/36 (× 5) | (Evening primrose meal) |
| Kneading | 45/5/36 (× 3) | |
| Conveying | 36/36 | |
| Kneading | 45/5/24 (× 3) | |
| Conveying | 16/16 | |
| | 36/36 (× 2) | |
| Kneading | 45/5/12 (× 2) | |
| | 90/5/24 | |
| Conveying | 36/36 | |
| Kneading | 45/5/12 (× 2) | |
| | 45/5/12 | |
| Conveying | 36/36 (× 5) | |
| | 24/24 (× 4) | |

### Example 24

20 kgs of evening primrose meal was run through a Magico EMC70 electric mill from AMA S.p.A. fitted with a 1 mm sieve to break up any agglomerated clumps. The resultant powder was then mixed with 30% by weight of sorbitol (sieved through a 2 mm sieve) in a tumble mixer to create a mixed powder of about 26 kgs weight. This mixture was then compounded with Ingeo 3251 D PLA in a ratio of 64:36 evening primrose meal/sorbitol:PLA on a Werner and Pfleiderer ZSK 25 twin-screw compounder fitted with a ZS-B 25 twin-screw side feeder. The screw profile used is given in Table 1 and the respective Injection points for the component materials were as per Example 23. All other details were as per Example 23.

### Examples 25-26

Compounded pellets from Examples 23-24 were separately mixed in equal weight portions with compounded pellets containing 60% Ingeo 3251D PLA and 40% wood cellulose fiber (supplied by Sappi Maastricht BV) and fed into the hopper of a Negri Bossi v55 injection moulding machine with a 32 mm diameter screw and a L/D ratio of 20:1 operating at temperatures ranging from 130 to 185° C. Each molten plasticized mixture was injection moulded in a single-cavity tool fitted with a single-drop hotrunner system into capsules suitable for use in a Nespresso-style coffee machine.

### Example 27

Representative coffee capsules from Examples 12-18 and 25-27 were filled to level capacity with ground coffee grains and sealed with self-sealing aluminium coffee capsule lids. Filled pods were then tested in a standard Nespresso coffee machine to produce a volume of filtered coffee. All capsules tested produced approximately the same volume of coffee as expelled from a commercial Nespresso capsule.

### Example 28

10 kgs of evening primrose meal was run through a Magico EMC70 electric mill from AMA S.p.A. fitted with a 1 mm sieve to break up any agglomerated clumps. The resultant powder was then mixed with 30% by weight of xylitol (sieved through a 2 mm sieve) in a tumble mixer to create a mixed powder of about 13 kgs weight. This mixture was then compounded with BioPBS FZ71PM (PTT MCC Biochem Company Ltd) in a ratio of 30:70 evening primrose meal/xylitol:PBS on a Werner and Pfleiderer ZSK 25 twin-screw compounder fitted with a ZS-B 25 twin-screw side feeder. The screw profile used is given in Table 1 and the respective injection points for the component materials were as per Example 23 except that all of the barrel temperatures were set 10° C. higher. All other details were as per Example 23.

### Example 29

Compounded pellets from Example 28 were fed into the hopper of a Krauss Maffei 120-180 PX injection moulding machine with a 25 mm diameter screw operating at temperatures ranging from 180 to 200° C. The molten plasticised mixture was injection moulded in a two-cavity tool fitted with a thermal gate hotrunner system into flip-top caps.

### Example 30

Fifteen representative coffee capsules from Example 15 (weight: 2.50±0.01 g) were mixed into 2 kgs of commercially purchased topsoil (passed through a 4 mm sieve) containing enough distilled water to saturate (defined by not leaving any standing water) the soil in a 5 L Pyrex glass beaker covered with 20 cm diameter watch glass. The beaker was placed inside a Unitemp temperature-controlled oven set at 58° C. (as per the thermophilic incubation period as detailed in ISO20200-2015). The trial was left undisturbed for separate periods of 21 days up to a total of 90 days.

Upon extraction and cooling to room temperature of the glass beaker at the end of each 21 day trial period, the soil was carefully broken apart to extract any intact capsules. Following extraction of both capsules and the larger pieces of broken capsules the soil was again sifted through a 4 mm sieve to extract any remaining pieces. All capsules were dried and then carefully brushed with a toothbrush to remove any attached dirt before being photographed and returned to re-saturated soil for another 21 day trial period until the end of the 90 day trial period. At the end of the 90 day trial period all capsules had disintegrated into pieces with less than 30% by weight not passing through a 4 mm sieve.

### SUMMARY

Examples 1-6 and 8-10 illustrate polymer composites with a high loading of oilseed meal powder. In Examples 7, 11, 25 and 26, filler materials have been used.

All formulations allowed the preparation of a disposable article, in Examples 12-18 and 25-26 a coffee capsule, Examples 19-22 a drink stirrer stick, and Example 29 flip-top caps. The coffee capsules were strong enough to be used in a Nespresso® coffee machine, as shown in Example 27. Moreover, the coffee capsules made from evening primrose meal proved to be highly biodegradable, as shown in Example 30.

The16alendtion can be summarized by the following clauses:
1. Polymer composite comprising:
   a. polymer in an amount of 5-94.5% by weight of the overall weight;
   b. milled oilseed meal, in an amount of at least 5% by weight of the overall weight;
   c. plasticizer in an amount from 5-50% w/w of component b);
   d. optional filler, and
   e. optional additive,
      wherein
         c) is a solid plasticizer with a melting temperature in the range of 55 to 210° C.
2. Polymer composite as claimed in clause 1, wherein component a) comprises a biodegradable polymer, preferably PLA, or derivatives or polymer blends thereof.
3. Polymer composite as claimed in clause 2, wherein component a) is present in an amount of 30-70% by weight of the overall weight, preferably in an amount of 30-50% by weight of the overall weight.
4. Polymer composite as claimed in any of the preceding clauses, wherein component b) comprises milled borage meal, or milled rosehip meal, or milled Ahiflower meal, or milled evening primrose meal, or milled blackcurrant meal, or a mixture thereof.
5. Polymer composite as claimed in any of the preceding clauses, comprising a mixture of milled oilseed meal and up to 50% w/w of component b) of milled expeller/cake, milled pomace, milled distillers' grain, milled brewer's grain (or brewer's spent grain/draff), milled biscuit meal or individual components thereof, milled whole seeds, milled whole roots, milled whole beans, milled stems and/or leaves, milled whole grain flour of cereal grass, flour of pulse, or a mixture thereof.
6. Polymer composite as claimed in any of the preceding clauses, wherein component b) or the mixture of claim 5 is present in an amount of 30-70% by weight of the overall weight.
7. Polymer composite as claimed in any of the preceding clauses, comprising polyols, polyfunctional alcohols, amphipolar plasticizers such as carboxylic acids and esters, for instance mono, di-, and tri-glyceride esters; mono-, di- and oligosaccharides, or mixtures thereof, as component c).
8. Polymer composite as claimed in any of the preceding clauses, wherein component c) is present in an amount from 22 to 40% w/w of component b).
9. Polymer composite as claimed in any of the preceding clauses, comprising as component d) either a natural fibre, preferably cellulose or lignocellulose fibres, and/or a mineral filler preferably selected from carbonates (including bicarbonates), phosphates, ferrocyanides, silica, silicates, aluminosilicates (including all forms of clay minerals and talc), titanium dioxide, and/or a carbon-based filler, or combinations thereof.
10. Polymer composite as claimed in any of the preceding clauses, wherein component d) is present in an amount from 1-40% by weight of the overall weight.
11. Polymer composite as claimed in any of the preceding clauses, comprising compatibilizers, fragrances, heat and UV stabilizers, and/or colouring agents or a mixture thereof as additive.
12. A process for preparing the polymer composite as claimed in any of the preceding clauses, wherein the polymer composite is made by hot compounding techniques, where the components are combined under heat and shearing forces that bring about a state of molten plastic (fluxing) which is shaped into the desired product, cooled and allowed to develop ultimate properties of strength and integrity, preferably by 17alendaring, extrusion, injection and compression moulding.
13. The process of the preceding clause, carried out at temperatures in the range of 130 to 210° C.
14. The process of clause 12 or 13, carried out in two steps, forming an intermediate first in a first step and combining the intermediate with the remainder of the components in a second step.
15. A solid article comprising the polymer composite as claimed in any of the preceding clauses 1-11.
16. The solid article of the preceding clause, in the form of a compounded pellet, extruded work-piece, injection-moulded article, blow moulded article, film or rota-moulded plastic article, two-part liquid moulded article, laminate, 3D printer filament, felt, woven fabric, knitted fabric, embroidered fabric, nonwoven fabric, geotextiles, fibre or a solid sheet.
17. The solid article of clause 15 or 16, in the form of a coffee pod, cutlery, food tray, or single-serve packaging.
18. An intermediate as prepared by the process of clause 14, for use in the preparation of a polymer composite as claimed in any of the preceding clauses 1-11.

What is claimed is:

1. A polymer composite having an overall weight, comprising:
(a) a polymer in an amount of 5-94.5% by weight of the overall weight;
(b) milled oilseed meal, in an amount of at least 5% by weight of the overall weight; and
(c) a plasticizer in an amount of 5-50% w/w of the milled oilseed meal;
wherein the plasticizer is a solid plasticizer having a melting temperature in the range of 70 to 210° C.

2. The polymer composite of claim 1, wherein the polymer is a biodegradable polymer chosen from polyglycolide (PGA), polylactide or poly(lactic acid) (PLA), poly(lactide-co-glycolide) (PLGA), polycaprolactone (PCL), poly(butylene succinate) (PBS), copolymers of PBS, poly(butylene succinate-co-adipate) (PBSA), poly(butylene adipate-co-terephtalate) (PBAT), a linear copolymer of N-acetyl-glucosamine and N-glucosamine with β-1,4 linkage, cellulose acetate (CA), poly(hydroxybutyrate) (PHB), polyhydroxyalkanoates (PHA), poly(hydroxybutyrate-co-hydroxyvalerate) (PHBV), and mixtures, derivatives, and polymer blends thereof.

3. The polymer composite of claim 1, wherein the polymer is present in an amount of 30-70% by weight of the overall weight.

4. The polymer composite of claim 1, wherein the milled oilseed meal is chosen from milled borage meal, milled rosehip meal, milled Ahiflower meal, milled evening primrose meal, milled blackcurrant meal, and mixtures thereof.

5. The polymer composite of claim 1, comprising a mixture of milled oilseed meal and up to 100% w/w of milled oilseed meal chosen from milled expeller/cake, milled pomace, milled distillers' grain, milled brewer's grain, brewer's spent grain/draff, milled biscuit cereal meal and individual components thereof, coffee grounds, milled whole seeds, milled whole roots, milled whole beans, milled stems and leaves, milled whole grain flour of cereal grass, flour of pulse, and mixtures thereof.

6. The polymer composite of claim 1, wherein the milled oilseed meal is present in an amount of 20-70% by weight of the overall weight.

7. The polymer composite of claim 1, wherein the plasticizer is chosen from polyols, polyfunctional alcohols, amphipolar plasticizers, carboxylic acids and esters, mono, di-, and tri-glyceride esters, mono-, di- and oligosaccharides, and mixtures thereof.

8. The polymer composite of claim 1, wherein the plasticizer is present in an amount from 22-40% w/w of the milled oilseed meal.

9. The polymer composite of claim 1, further comprising a filler chosen from a natural fibre, cellulose, lignocellulose fibres, a mineral filler, carbonates, bicarbonates, phosphates, ferrocyanides, silica, silicates, aluminosilicates, clay minerals, mica, talc, titanium dioxide, carbon-based fillers, and combinations thereof.

10. The polymer composite of claim 1, further comprising a filler, wherein the filler is present in an amount of 1-40% by weight of the overall weight.

11. The polymer composite of claim 1, further comprising an additive chosen from compatibilizers, fragrances, heat and UV stabilizers, colouring agents, and mixtures thereof.

12. A process for preparing a polymer composite, comprising a polymer; milled oilseed meal; and a plasticizer, wherein the plasticizer is a solid plasticizer having a melting temperature in the range of 70 to 210° C., as components, said process comprising combining the components under heat and shearing forces, forming a molten plastic; shaping the molten plastic into a form by a method chosen from calendering, extrusion, injection and compression moulding; cooling the desired form for a period, whereby strength and integrity of the form are generated.

13. The process of claim 12, wherein said step of combining the components under heat and shearing forces is carried out at temperatures in the range of 130 to 215° C.

14. The process of claim 12, wherein said process comprises the steps of forming an intermediate from at least one component, and combining the intermediate with the previously unused components.

15. A solid article having an overall weight, comprising a polymer; milled oilseed meal; and a plasticizer, wherein the plasticizer is a solid plasticizer having a melting temperature in the range of 70 to 210° C.

16. The solid article of claim 15, having a form chosen from a compounded pellet, an extruded work-piece, an injection-moulded article, a blow moulded article, a rota-moulded plastic article, a two-part liquid moulded article, a laminate, a 3D printer filament, felt, woven fabric, knitted fabric, embroidered fabric, nonwoven fabric, geotextiles, a fibre, and a solid sheet.

17. The solid article of claim 15, having a form chosen from a coffee capsule, cutlery, straw, drink stirrer, food tray, a single-serve packaging, such as a cup, cap, container, and a single-use item.

18. The polymer composite of claim 3, wherein the polymer is present in an amount of 30-50% by weight of the overall weight.

19. The polymer composite of claim 5, wherein the mixture is present in an amount of 20-70% by weight of the overall weight.
